(19) United States
(12) Patent Application Publication
(10) Pub. No.: US 2018/0249212 A1
(43) Pub. Date: Aug. 30, 2018

(54) VIEWING LOG ANALYSIS DEVICE, METHOD, AND STORAGE MEDIUM

(71) Applicant: KABUSHIKI KAISHA TOSHIBA, Tokyo (JP)

(72) Inventors: Kouta Nakata, Tokyo (JP); Yoshiaki Mizuoka, Kamakura Kanagawa (JP); Yaling Tao, Kawasaki Kanagawa (JP)

(21) Appl. No.: 15/701,964

(22) Filed: Sep. 12, 2017

(30) Foreign Application Priority Data
Feb. 27, 2017 (JP) 2017-034924

(51) Int. Cl. H04N 21/442; H04N 21/466; H04N 21/45; H04N 21/61; H04N 21/431; H04N 21/845

(52) U.S. Cl. CPC H04N 21/44222; H04N 21/4667; H04N 21/4532; H04N 21/8456; H04N 21/431; H04N 21/44204; H04N 21/6125

(57) ABSTRACT

According to one embodiment, a viewing log analysis device includes a hardware processor. The hardware processor is configured to acquire a viewing log for each device of a plurality of devices, the viewing log including identification of a day when the broadcast program is viewed and a time zone, generate viewing feature information including a viewing feature amount with respect to each of the plurality of devices, generate a viewing group including a set of devices from the plurality of devices based on similarity or distance between the viewing feature information, and display the viewing habit in the viewing group on the basis of the viewing feature amount with respect to each of the devices from the set of devices in the viewing group.

### CROSS-REFERENCE TO RELATED APPLICATIONS

This application is based upon and claims the benefit of priority from Japanese Patent Application No. 2017-034924, filed Feb. 27, 2017, the entire contents of which are incorporated herein by reference.

### FIELD

Embodiments described herein relate generally to a viewing log analysis device, a method, and a storage medium.

### BACKGROUND

In recent years, for example, there is known a technique that a history of a broadcast program (contents) viewed by a viewer is acquired as a viewing log from a video viewing device such as a television (hereinafter, referred to as viewing device) connected to a network such as the Internet.

When a common viewing habit is found out in a number of viewers by analyzing such a viewing log, there is a possibility to use the viewing habit to produce the broadcast program and to improve the quality of services of developing advertisements.

However, knowledge and assumptions of a person are necessary in order to find the viewing habit from the viewing log, and it is difficult to find an unknown viewing habit.

For example, in a case where there is an assumption that the same viewer group is viewing broadcast programs A, B, and C, it is possible to find the viewing habit based on the assumption.

However, in a case where a combination of such broadcast programs is unknown, it is difficult to find the viewing habit with respect to a combination of new broadcast programs.

In addition, it is more difficult to find an unknown viewing habit due to the variety of viewing habits on the viewing device, and there has been increasing demand for establishing and supporting the knowledge and the assumptions of the viewing habit through an analysis using a large amount of the viewing logs.

### BRIEF DESCRIPTION OF THE DRAWINGS

FIG. 1 is a block diagram illustrating an example of a configuration of a viewing log analysis device according to a first embodiment;

FIG. 2 is a diagram illustrating an example of a data structure of a viewing log;

FIG. 3 a flowchart illustrating an example of a procedure of the viewing log analysis device;

FIG. 4 is a diagram for specifically describing viewing feature information of a viewing device;

FIG. 5 is a diagram illustrating an example in which the viewing feature information of the viewing device is visualized in a graph format;

FIG. 6 is a diagram illustrating an example of a data structure of viewing group information;

FIG. 7 is a diagram illustrating a displaying example of the viewing feature information of a viewing group;

FIG. 8 is a diagram illustrating an example in which the viewing feature information of a plurality of viewing groups is listed;

FIG. 9 is a diagram illustrating an example of a data structure of time zone name information;

FIG. 10 is a diagram illustrating an example of a data structure of channel name information;

FIG. 11 is a flowchart illustrating an example of a procedure when a viewing habit name is generated;

FIG. 12 is a diagram illustrating an example of a network configuration in a case where the viewing log analysis device operates as a server device;

FIG. 13 is a diagram illustrating an example of a data structure of a viewing log according to a second embodiment;

FIG. 14 is a diagram for specifically describing the viewing feature information of the viewing device;

FIG. 15 is a diagram illustrating an example in which the viewing feature information of the viewing device is visualized in a graph format;

FIG. 16 is a diagram illustrating a displaying example of the viewing feature information of a viewing group;

FIG. 17 is a diagram illustrating an example in which the viewing feature information of all days is displayed;

FIG. 18 is a diagram illustrating an example in which the viewing feature information of all days is displayed;

FIG. 19 is a diagram illustrating an example of a data structure of viewing type name information; and

FIG. 20 is a flowchart illustrating an example of a procedure when the viewing habit name is generated.

### DETAILED DESCRIPTION

In general, according to one embodiment, a viewing log analysis device includes a hardware processor. The hardware processor is configured to acquire a viewing log for each device of a plurality of devices used to view the broadcast program, the viewing log including identification of a day when the broadcast program is viewed in the device and a time zone, generate viewing feature information including a viewing feature amount related to the combination of the day and the time zone in the viewing log with respect to each of the plurality of devices, generate a viewing group including a set of devices from the plurality of devices based on similarity or distance between the viewing feature information, and display the viewing habit in the viewing group on the basis of the viewing feature amount in the viewing feature information with respect to each of the devices from the set of devices in the viewing group.

Various embodiments will be described hereinafter with reference to the accompanying drawings.

### FIRST EMBODIMENT

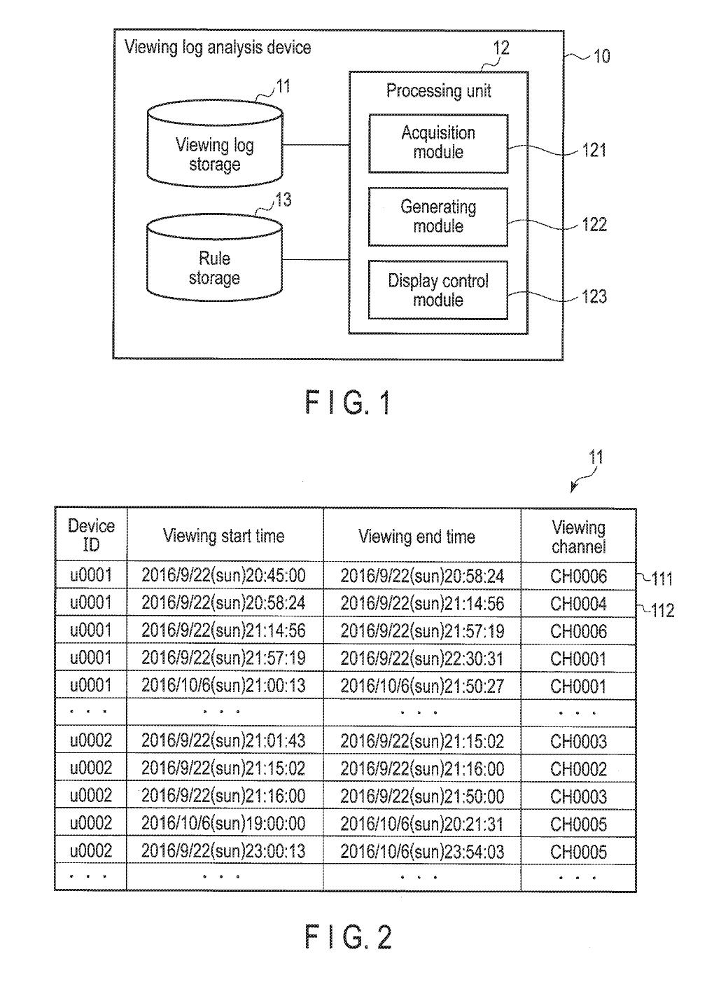

FIG. 1 is a block diagram illustrating an example of a configuration of a viewing log analysis device according to a first embodiment.

As illustrated in FIG. 1, a viewing log analysis device 10 includes a viewing log storage 11, a processing unit 12, and a rule storage 13.

In this embodiment, the viewing log storage 11 and the rule storage 13 are realized using a storage device (memory) such as an HDD (Hard Disk Drive) and an SSD (Solid State Drive) which are provided in the viewing log analysis device 10. In addition, the processing unit 12 is realized by a computer which executes a program stored in the storage device and is provided in the viewing tog analysis device 10. The processing unit 12 includes a hardware processor and the like connected to the storage device.

In the viewing log storage 11, a history of viewing a broadcast program of a viewer is stored as a viewing log in a video viewing device (hereinafter, referred to as viewing device) used to view a broadcast program of a television. In the viewing log storage 11, there are stored a number of viewing logs collected from each of a plurality of viewing devices which can collect the viewing log. The viewing log stored in the viewing log storage 11 includes, for example, a day and a time zone when the broadcast program is viewed in the viewing device. Further, in this embodiment, the expression “the viewer views the broadcast program” means that the broadcast program is displayed in the viewing device. In addition, the “broadcast program” may be any broadcast program as long as it can be viewed in the viewing device (for example, video contents such as a CM or a moving image delivered on the Internet). A data structure of the viewing log will be described below.

Further, in this embodiment, the viewing log storage 11 will be described as to be included in the viewing log analysis device 10. However, the viewing log storage 11 may he provided in an external server device of the viewing log analysis device 10.

The processing unit 12 performs a process of analyzing a number of viewing logs stored in the viewing log storage 11, and extracting a viewing habit in the plurality (set) of viewing devices which collect the viewing log.

The processing unit 12 includes an acquisition module 121, a generating module 122, and a display control module 123. The acquisition module 121 acquires the viewing log stored in the viewing log storage 11.

The generating module 122 generates viewing feature information for each viewing device, which includes a viewing feature amount related to a combination of the day and the time zone which are included in the viewing log acquired by the acquisition module 121.

The generating module 122 generates a viewing group which includes the plurality of viewing devices of which the generated viewing feature information is similar. Further, the viewing group generated by the generating module 122 corresponds to a group of viewing devices with which the broadcast program is viewed by the similar viewing habit.

The display control module 123 visualizes and displays the viewing habit in the viewing group on the basis of the viewing feature information (viewing feature amount) generated with respect to each of the plurality of viewing devices included in the viewing group generated by the generating module 122.

The rule storage 13 stores rule information in advance to generate a name indicating the viewing habit displayed by the display control module 123. The details of a process of generating the name indicating the viewing habit using the rule information stored in the rule storage 13 will be described below.

FIG. 2 illustrates an example of the data structure of the viewing log stored in the viewing log storage 11 illustrated in FIG. 1.

As illustrated in FIG. 2, the viewing log stored in the viewing log storage 11 includes a viewing start time, a viewing end time, and a viewing channel in association with a device ID.

The device ID is identification information for identifying the viewing device collecting the viewing log including the device ID.

The viewing start time indicates a date when the broadcast program starts to be viewed in the viewing device identified by the device ID associated with the viewing start time. Specifically, the viewing start time includes a date, a day, and a time when the broadcast program is viewed.

The viewing end time indicates a date when the viewing of the broadcast program ends in the viewing device identified by the device ID associated with the viewing end time. Specifically, the viewing end time includes a date, a day, and a time when the viewing of the broadcast program ends.

Further, the time zone in which the broadcast program is viewed can be specified in the viewing log from the viewing start time and the viewing end time included in the viewing log.

The viewing channel indicates a channel in which the broadcast program viewed in the time zone from the viewing start time to the viewing end time associated with the viewing channel is broadcasted.

In the example illustrated in FIG. 2, for example, a plurality of viewing logs which includes viewing logs 111 and 112 are illustrated as the viewing log collected from the viewing device identified by the device ID “u0001”. Further, the device ID “u0001” is included in the viewing log collected from the viewing device identified by the device ID “u0001”.

Specifically, the viewing log 111 includes the viewing start time “2016/9/22 (Sun) 20:45:00”, the viewing end time “2016/9/22 (Sun) 20:58:24”, and the viewing channel “CH6” in association with the device ID “u0001”. According to the viewing log 111, it is indicated that the broadcast program on CH6 is viewed in the viewing device identified by the device ID “u0001” during a period from 20:45:00 (Sun) in Sep. 22, 2016 to 20:58:24 (Sun) in Sep. 22, 2016.

In addition, the viewing log 112 includes the viewing start time “2016/9/22 (Sun) 20:58:24”, the viewing end time “2016/9/22 (Sun) 21:14:56”, and the viewing channel “CH4” in association with the device ID “u0001”. According to the viewing log 112, it is indicated that the broadcast program on CH4 is viewed in the viewing device identified by the device ID “u0001” during a period from 20:58:24 (Sun) in Sep. 22, 2016 to 21:14:56 (Sun) in Sep. 22, 2016.

Further, the viewing log Ill is a viewing log which is stored in the viewing log storage 11 in a case where the power of the viewing device is turned on at the viewing start time included in the viewing log 111 (that is, the viewing of the broadcast program on CH6 starts), and the channel is changed to CH4 at the viewing end time included in the viewing log 111 (that is, the viewing of the broadcast program on CH6 ends). On the other hand, the viewing log 112 is a viewing log stored in the viewing log storage 11 in a case where the channel is changed to CH4 at the viewing start time included in the viewing log 112 as described above, and the channel is changed to CH6 at the viewing end time included in the viewing log 112.

While not illustrated herein in detail, the viewing, log storage 11 also stores a viewing log collected from the viewing device identified by the device ID “u0001” besides the viewing logs 111 and 112. In addition, for example, the plurality of viewing logs including the device ID “u0002” is included in the example illustrated in FIG. 2 as the viewing log collected from the viewing device identified by the device ID “u0002”.

Further, (the data structure of) the viewing log collected from the viewing device identified by the device ID “u0002” is the same as the viewing log (for example, the viewing logs 111 and 112) collected from the viewing device identified by the device ID “u0001”, and thus the description thereof will be omitted,

In FIG. 2, there is illustrated only the viewing logs collected from the viewing device which is identified by the device IDs “u0001” and “u0002”. However, the viewing logs collected from the other viewing devices are similarly stored in the viewing log storage 11.

Further, the broadcast program on the viewing channel included in the viewing log during a period from the viewing start time to the viewing end time included in the viewing log may be changed. Even in this case, it is assumed that the one viewing log is stored in this embodiment.

In other words, the viewing log in this embodiment is assumed to indicate one viewing behavior. For example, the viewing behavior indicated by one viewing log starts by changing the channel or by turning on the power of the viewing device, and ends by changing the channel or by turning off the power of the viewing device.

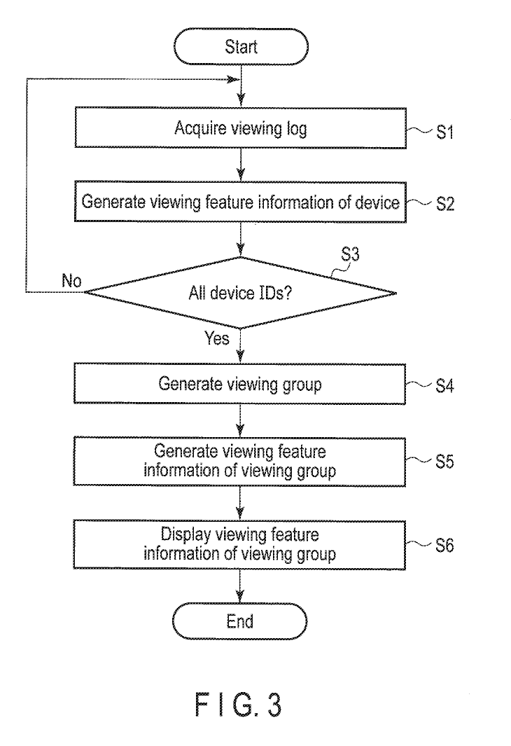

Next, a procedure of the viewing log analysis device 10 according to this embodiment will be described with reference to a flowchart of FIG. 3.

In this embodiment, the process of the following Steps S1 and S2 are performed on (the viewing device identified by) the device ID included in the viewing log stored in the viewing log storage 11 by the processing unit 12 in the viewing log analysis device 10. In the following description, the device ID targeted in the process will be called a target device ID, and the viewing device identified by the target device ID will be called a target viewing device.

First, the acquisition module 121 acquires, for example, the viewing log collected from the target viewing device in a predetermined time period from the viewing log storage 11 (Step S1). In this case, the acquisition module 121 acquires the viewing log which is a viewing log including the target device ID and of which the time zone from the start of the viewing to the end of the viewing falls within the predetermined time period. Further, the predetermined time period includes, for example, one month. Hereinafter, the viewing log acquired in Step S1 is called as the viewing log of the target viewing device.

Next, the generating module 122 generates the viewing feature information (hereinafter, referred to as the viewing feature information of the target viewing device) which includes the viewing feature amount (channel viewing feature amount) related to a combination of the day, the time zone, and the viewing channel included in the viewing log on the basis of the viewing log of the target viewing device (Step S2). In this case, the generating module 122 calculates a ratio of a time (viewing time) for viewing the broadcast program on each viewing channel in each time zone of each day as the viewing feature amount for example.

Herein, the description will be given for example about a case where a ratio of a time for viewing the broadcast program on CH1 in the time zone from 0 to 1 o'clock on Sunday (that is, the viewing feature amount related to a combination of Sunday, the time zone from 0 to 1 o'clock, and CH1). In this case, the generating module 122 specifies the time for viewing the broadcast program on CH1 between 0 to 1 o'clock on Sunday on the basis of the viewing log of the target viewing device. The generating module 122 calculates the viewing feature amount by dividing the specified time by one hour from 0 to 1 o'clock. For example, in a case where the time for viewing the broadcast program on CH1 between 0 to 1 o'clock on Sunday is 30 minutes, “0.5” is calculated as the viewing feature amount.

Further, as described above, in a case where the viewing log of the target viewing device is collected in a period of one month for example, the generating module 122 calculates an average value of the ratio of the time for viewing the broadcast program on CH1 between 0 and 1 o'clock on every Sunday in the period as the viewing feature amount. In this way, since the average value in a predetermined time period is set as the viewing feature amount, for example, even when there is a day such as a holiday (festival) affecting a normal viewing habit (that is, a day when the viewing habit of the broadcast program is different from that of a normal day), the influence can be alleviated.

The generating module 122 performs the process on each combination of the day, the time zone, and the viewing channel to generate the viewing feature information including the viewing feature amount calculated for each combination.

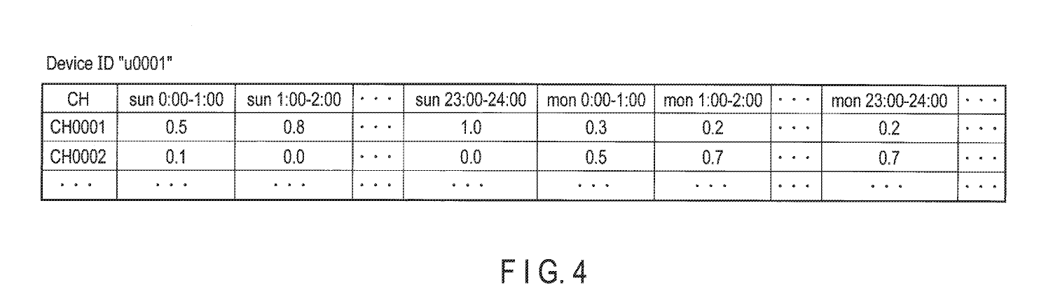

The description will be given in detail about the viewing feature information of the target viewing device which is generated in Step S2 with reference to FIG. 4. As illustrated FIG. 4, the viewing feature information includes the viewing feature amount which is calculated for each of the combination of the day, the time zone, and the viewing channel.

In the example illustrated in FIG. 4, the viewing feature information includes a viewing feature amount of “0.5” in association with the viewing channel “CH1” and “Sun 0:00-1:00” which is the combination of the day and the time zone. Therefore, the example shows that the ratio (viewing feature amount.) of the time for viewing the broadcast program on CH1 between 0 and 1 o'clock on Sunday is 0.5. In other words, the broadcast program on CH1 is viewed in the target viewing device for 30 minutes in one hour from 0 to 1 o'clock on Sunday.

In addition, the viewing feature information includes the viewing feature amount of “0.8” in as with the viewing channel “CH1”, and the combination of the day and the time zone of “Sun 1:00-2:00”. Therefore, the example shows that the ratio (viewing feature amount) of the time for viewing the broadcast program on CH1 between 1 and 2 o'clock on. Sunday is 0.8. In other words, the broadcast program. on CH1 in one hour from 1 to 2 o'clock on Sunday is viewed in the target viewing device for 48 minutes.

As it in FIG. 4, the ratio of the time for viewing the broadcast program on CH1 in the time zone every one hour on Sunday is included in the viewing feature information as the viewing feature amount.

Herein, while the description has been given about Sunday, even in the case of the other days, the ratio of the time for viewing the broadcast program on CH1 in the time zone every one hour is similarly included in the viewing feature information as the viewing feature amount. In addition, also the viewing channel other than CH1 is the same.

In the following description, among a plurality of viewing feature amounts included in the viewing feature information, a group of ratios (viewing feature amount) of the time for viewing the broadcast program on each viewing channel in each time zone on Sunday will be called the viewing feature information of Sunday for convenience' sake. Further, in this embodiment, each time zone of Sunday corresponds to a time from the start to the end of the broadcast program on each viewing channel on Sunday. For example, the time zone includes each time zone from 5 o'clock on Sunday to 5 o'clock on Monday next to Sunday, and is denoted as 5 to 29 o'clock. Herein, while the description has been given mainly about Sunday, it is the same on the other days, and thus the description thereof will be omitted. In addition, the following description is also the same.

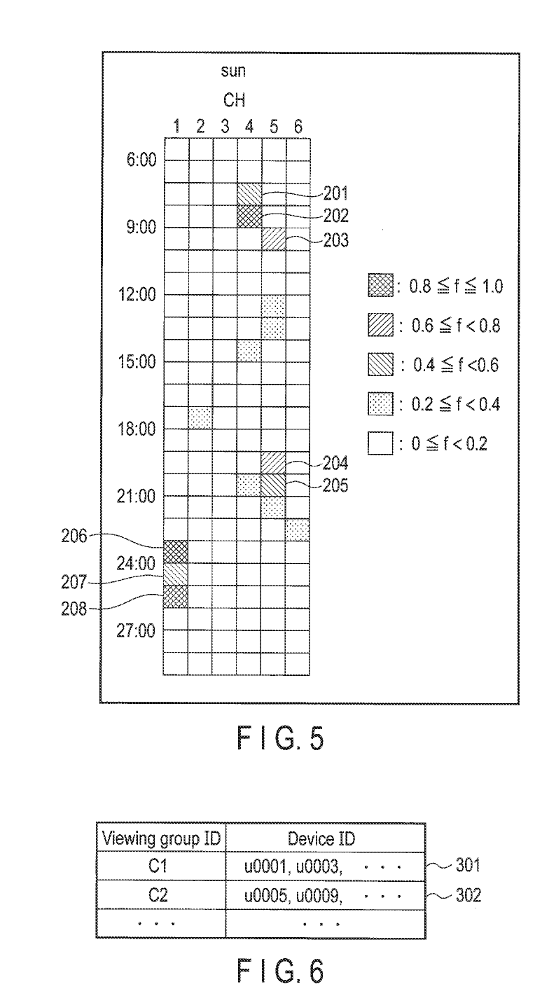

Herein, the description will be given with reference to FIG. 5 about an example of visualizing (imaging) the viewing feature information of Sunday of the target viewing device in a graph format.

In FIG. 5, the vertical axis represents the time zone (time), and the horizontal axis represents the viewing channel. The graph configured by the vertical axis and the horizontal axis includes a plurality of areas, each of which corresponds to the time zone and the viewing channel.

Each of the plurality of areas in such a graph is differently assigned with color according to (the value of) the viewing feature amount which is associated with each time zone and each viewing channel. Further, the viewing feature amount associated with each time zone and each viewing channel is a ratio of the time for viewing the broadcast program on the viewing channel in the time zone.

The color assigned to each of the plurality of areas includes, for example, first to fifth colors. Herein, in a case where the viewing feature amount is set to f, a first color is, for example, a color assigned to the area according to the viewing feature amount of 0 or more and less than 0.2 (0≤f<0.2). A second color is, for example, a color assigned to the area according to the viewing feature amount of 0.2 or more and less than 0.4 (0.2≤f<0.4). A third color is, for example, a color assigned to the area according to the viewing feature amount of 0.4 or more and less than 0.6 (0.4≤f<0.6). A fourth color is, for example, a color assigned to the area according to the viewing feature amount of 0.6 or more and less than 0.8 (0.6≤f<0.8). A fifth color is, for example, a color assigned to the area according to the viewing feature amount of 0.8 or more and 1.0 or less (0.8≤f≤1.0).

In the example illustrated in FIG. 5, for example, an area 201 corresponding to the time zone from 7 to 8 o'clock and to CH4 is assigned by the third color, and an area 202 corresponding to the time zone from 8 to 9 o'clock and to CH4 is assigned by the fifth color. According to such a viewing feature amount, it is indicated that there is a habit of viewing the broadcast program on CH4 in the early morning on Sunday in the target viewing device.

In addition, in the example illustrated in FIG. 5, an area 203 corresponding to the time zone from 9 to 10 o'clock and to CH5 is assigned by the fourth color. According to such a viewing feature amount, it is indicated that there is a habit of viewing the broadcast program on CH5 in the morning on Sunday in the target viewing device.

In addition, in the example Illustrated in FIG. 5, an area 204 corresponding to the time zone from 19 to 20 o'clock and to CH5 is assigned by the fourth color, and an area 205 corresponding to the time zone from 20 to 21 o'clock and to CH5 is assigned by the third color. According to such a viewing feature amount, it is indicated that there is a habit of viewing the broadcast program on CH5 in a golden time on Sunday in the target viewing device shows a habit.

Further, in the example illustrated in FIG. 5, an area 206 corresponding to the time zone from 23 to 24 o'clock and to CH1 is assigned by the fifth color, an area 207 corresponding to the time zone from 24 to 25 o'clock and to CH1 is assigned by the third color, and an area 208 corresponding to the time zone from 25 to 26 o'clock and to CH1 is assigned by the fifth color. According to such a viewing feature amount, it is indicated that there is a habit of viewing the broadcast program on CH1 in the middle of the night on Sunday in the target viewing device.

While the description in FIG. 5 has been given about an example of visualizing the viewing feature information of Sunday of the target viewing device in a graph format, this is the same even in the case of the viewing feature information of the other days of the target viewing device.

Further, the description in the example illustrated in FIG. 5 has been given such that the viewing feature amount corresponding to each time zone and each channel is displayed using a plurality of colors (first to fifth colors). However, the viewing feature amount may be displayed in other formats as long as a degree of the viewing feature amount can be discriminated.

Returning to FIG. 3, it is determined whether the process of Steps S1 and S2 described above are performed on (the viewing devices identified by) all the device IDs which are included in the viewing log stored in the viewing log storage 11 (that is, the viewing feature information of all the viewing devices are generated) (Step S3).

In a case where it is determined that the process is not performed on all the device IDs (NO of Step S3), the procedure returns to Step S1 to repeatedly perform the process. In this case, the device ID on which the process is not performed is set to the target device ID, and the process of Steps S1 and S2 are performed.

On the other hand, in a case where it is determined that the process is performed on all the device IDs (YES of Step S3), the generating module 122 generates (viewing group information indicating) the viewing group which includes the plurality of viewing devices similar in the viewing feature information on the basis of (the viewing feature amount included in) the generated viewing feature information for all the viewing devices in Step S2 (Step S4).

In this embodiment, the generating module 122 mechanically generates, for example, a viewing group by using a clustering method of unsupervised learning. Specifically, as a KMeans method is used as an example of the clustering method to automatically classify all the viewing devices into K clusters (a group of viewing device). Further, K is an integer of 2 or more.

According to the KMeans method, after all the viewing devices are randomly classified into the K clusters, a distance from the center of each cluster up to the viewing feature information of each viewing device is calculated. The center of each cluster is calculated from (the viewing feature amount included in) the viewing feature information of the viewing device classified into each cluster. Each of the viewing devices is classified again into the cluster in which the calculated distance is shortest. In the KMeans method, the process is repeatedly performed until all the viewing devices are classified into appropriated clusters, and thus the automatic classification is possible.

The generating module 122 sets the number of clusters to 20 (that is, K=20) for example in the KMeans method so as to perform the automatic classification. As a result, each of the viewing devices is classified into one cluster among twenty clusters. Further, a group of viewing devices classified into each of twenty clusters corresponds to the viewing group generated in Step S4.

Further, in a clustering by the KMeans method using the viewing feature information of the viewing device, the distance to the center of each cluster is changed due to a slight deviation of (the viewing feature amount contained in) the viewing feature information, and the viewing devices in a near distance may be intuitively classified into different clusters (viewing group).

Therefore, in this embodiment, it is assumed that the clustering is performed using a compressed dimension feature amount obtained by dimensionally compressing the viewing feature information of the viewing device. Since the compressed dimension feature amount is hardly affected by a light change, it is possible to perform the automatic classification according to a human intuition. In the dimensional compression, it is possible to use an auto encoder which can efficiently compress a dimension. Since the auto encoder is able to perform the dimensional compression on an image with a high performance, the viewing feature information imaged as illustrated in FIG. 5 is dimensionally compressed by the auto encoder. Therefore, the dimensional compression can be performed with a high performance.

Further, the viewing habit of one day in the viewing device depends on the broadcast program on each viewing channel, and thus may he different depending on a day. Therefore, in Step S4, the generating module 122 generates the viewing group (performs the clustering) on the basis of the viewing feature Information of a specific day (for example, Sunday) of all the viewing devices. Therefore, the viewing group generated in Step S4 is a group of the viewing devices of which the viewing feature information of a specific day is similar (that is, the viewing habit on a specific day is common).

Herein, FIG. 6 illustrates an example of a data structure of the viewing group information which is generated in Step S4.

As illustrated in FIG, 6, the viewing group information includes a viewing group ID and the device ID in association with each other. The viewing group ID is identification information to identify the viewing group (cluster) which is obtained by classifying the viewing devices described above. The device ID is identification information to identify the (classified) viewing device belonging to (included in) the viewing group which is identified by the viewing group ID associated with the device ID.

In the example illustrated in FIG. 6, a plurality of pieces of viewing group information which includes viewing group information 301 and 302 in Step S4 are generated.

In the viewing group information 301, the viewing group ID “C1” and the device IDs “u0001, u0003, . . . ” are included in association with each other. According to the viewing group information 301, it is indicated that the plurality of viewing devices including the viewing devices identified by the device IDs “u0001” and “u0003” belong to the viewing group (cluster) identified by the viewing group ID “C1”. In other words, the viewing group information 301 indicates that the viewing group to which the plurality of viewing devices including the viewing devices identified by the device IDs “u0001” and “u0003” belong is generated in Step S4.

In addition, the viewing group ID “C2” and the device IDs “u0005, u0009, . . . ” are included in the viewing group information 302 in association with each other. According to the viewing group information 302, it is indicated that the plurality of viewing devices including the viewing devices identified by the device IDs “u0005” and “u0009” belong to the viewing group (cluster) identified by the viewing group ID “C2”. In other words, the viewing group information 302 indicates that the viewing group to which the plurality of viewing devices including the viewing devices identified by the device IDs “u0005” and “u0009” belong is generated in Step S4.

Further, the generated viewing feature information is similar in the plurality of viewing devices identified by the device IDs “u0001, u0003, . . . ” included in the viewing group information 301. Similarly, the generated viewing feature information is similar in the plurality of viewing devices identified by the device IDs “u0005, u0009, . . . ” included in the viewing group information 302. Therefore, in this embodiment, it can be said that the plurality of viewing devices belonging to one viewing group generated in Step S4 have a common viewing habit.

Herein, the description has been given only about (the plurality of viewing devices belonging to) the viewing groups identified by the viewing group IDs “C1” and “C2”. However, (the viewing group information indicating) the viewing groups are generated in Step S4 by the same number as the number (K) of clusters provided in the automatic classification described above.

Further, as described above, the viewing devices similar in the viewing feature information are classified into the same viewing group. Therefore, the respective viewing habits of the viewing group generated in Step S4 become different.

Returning to FIG. 3, the display control module 123 generates the viewing feature information of the viewing group on the basis of the viewing feature amount included in each viewing feature information of the plurality of viewing devices belonging to the viewing group generated in Step S4 (Step S5).

In this case, the display control module 123 calculates, for example, an average value of the viewing feature amount of the viewing device (that is, the viewing device belonging to the viewing group) identified by the device ID included in the viewing group information indicating the viewing group, and generates the viewing feature information including the average value (viewing feature amount).

Herein, the process of Step S5 will be described in detail. Herein, for convenience' sake, it is assumed that first to third viewing devices belong to the viewing group generated in Step S4.

As described above, the viewing feature amount relating to each combination of the day, the time zone, and the viewing channel is included in each viewing feature information of the first to third viewing devices.

Herein, in a case where the process of Step S4 described above is performed on the basis of the viewing feature information of Sunday, the display control module 123 calculates an average value of the viewing feature amount included in the viewing feature information of Sunday of the first to third viewing devices.

Specifically, the display control module 123 calculates the average value of the viewing feature amount (a ratio of a time for viewing the broadcast program on CH1 in a time zone from 0 to 1 o'clock on Sunday) included in each viewing feature information of the first to third viewing devices (for example, a viewing feature amount related to the combination of Sunday, the time zone from 0 to 1 o'clock, and CH1) as the viewing feature amount related to the combination of the time zone from 0 to 1 o'clock on Sunday and CH1 in the viewing group.

Herein, while the description has been given about the combination of Sunday, the time zone from 0 to 1 o'clock, and CH1, the display control module 123 can generate the viewing feature information of the viewing group (the viewing feature information of Sunday) by calculating the viewing feature amount (average value) similarly with respect to a combination of Sunday, another time zone, and another viewing channel. The viewing feature information of the viewing group generated herein is information indicating the viewing habit on Sunday of the viewing group.

Next, the display control module 123 visualizes and displays (the viewing feature amount included in) the viewing feature information of the viewing group generated in Step S5 (Step S6).

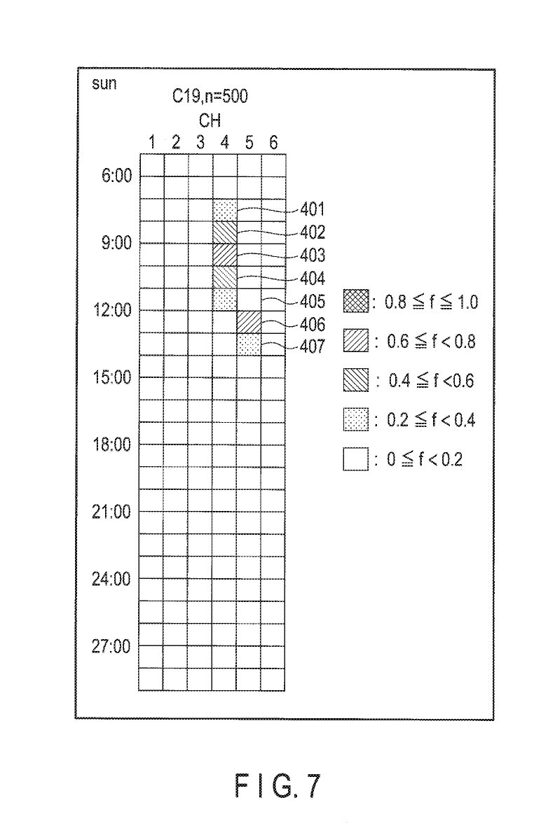

FIG. 7 illustrates a displaying example of the viewing feature information of the viewing group in Step S6. Further, in FIG. 7, there is illustrated an example in which the viewing feature information of one viewing group among the viewing feature information of K viewing groups generated in Step S5 is visualized (imaged) in a graph format.

In the upper portion of the graph illustrated in FIG. 7, “C19” is denoted as the viewing group ID for identifying the viewing group, and “500” is denoted as the number (n) of the viewing devices belonging to the viewing group. Further, the number of the viewing devices belonging to the viewing group corresponds to the number of device IDs included in the viewing group information in association with the viewing group ID for identifying the viewing group.

In addition, in FIG. 7, the vertical axis represents the time zone (time), and the horizontal axis represents the viewing channel. The graph configured by the vertical axis and the horizontal axis includes a plurality of areas in association with each time zone and each viewing channel.

Each of the plurality of areas in such a graph is differently assigned with color according to (the value of) the viewing feature amount which is associated with each time zone and each viewing channel. Further, the colors assigned to the plurality of areas is the same as the above description in FIG. 5, and thus the description thereof will be omitted.

In the example illustrated in FIG. 7, the second color is assigned to an area 401 corresponding to the time zone from 7 to 8 o'clock and CH4. In addition, the third color is assigned to an area 402 corresponding to the time zone from, 8 to 9 o'clock and CH4. In addition, the fourth color is assigned to an area 403 corresponding to the time zone from 9 to 10 o'clock and CH4. Further, the third color is assigned to an area 404 corresponding to the time zone from 10 to 11 o'clock and CH4. In addition, the second color is assigned to an area 405 corresponding to the tame zone from 11 to 12 o'clock and CH4.

In addition, the fourth color is assigned to an area 406 corresponding to the time zone from 12 to 13 o'clock and CH5. Further, the second color is assigned to an area 407 corresponding to the time zone from 13 to 14 o'clock and CH5.

Therefore, the viewing group identified by the viewing group ID “C19” (a group of 500 viewing devices) is visualized with a characteristic (habit) that the broadcast program on CH4 is viewed from the early morning and the morning, and the broadcast program on CH5 is viewed in the lunch time.

According to the viewing feature information of the visualized viewing group, it is possible to present the viewing habit of Sunday in the plurality of viewing devices (herein, 500 viewing devices).

While not illustrated herein in detail, the viewing group identified by the viewing group ID other than the viewing group ID “C19” illustrated in FIG. 7 can be similarly visualized and displayed.

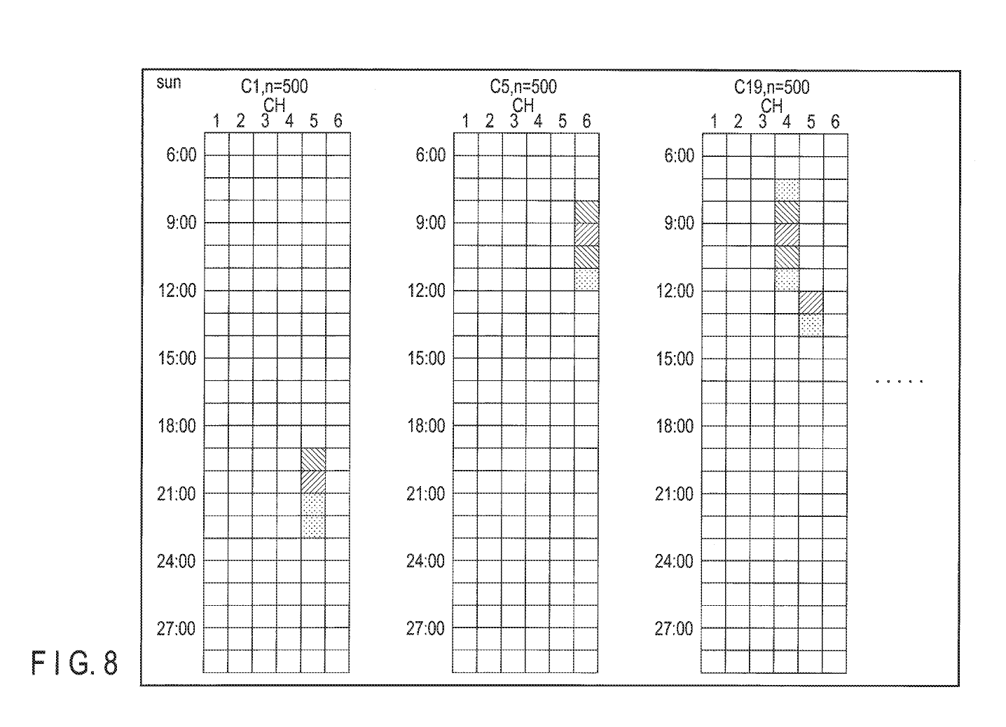

In addition, while the description in FIG. 7 has been given about an example in which the viewing feature information of one viewing group is displayed, the viewing feature information of the plurality of viewing groups may be listed as illustrated in FIG. 8 for example. In this case, the viewing feature information of the plurality of viewing groups visualized in a graph format may be arranged in a descending order of the number of the viewing devices belonging to the viewing group for example. Further, while only the viewing feature information of three viewing groups is illustrated in FIG. 8 for convenience' sake, the viewing feature information of all (for example, 20) the viewing groups may be displayed, or only the viewing feature information of the viewing group having a large number of viewing devices may be displayed.

Further, while the description in FIG. 3 has been mainly described such that the viewing feature amount of Sunday of each viewing group is displayed, the viewing habit of the other day may be presented by displaying the viewing feature information of the day of the viewing group.

Herein, as illustrated in FIG. 7 described above, the viewing habit can be presented by visualizing and displaying the viewing feature information of the viewing group. However, in particular, in a case where the viewing feature information of the viewing group is listed, it is difficult to intuitively represent the viewing habit in the viewing feature information visualized in a graph format.

Therefore, in this embodiment, the viewing habit based on the viewing feature information of the viewing group thus visualized and displayed is presented. Therefore, the name (hereinafter, referred to as viewing habit name) indicating an overview of the viewing habit is generated, and the viewing habit name is displayed together with (the graph of) the viewing feature information of the viewing group.

Further, the viewing habit name is generated using the rule information stored in the rule storage 13 included in the viewing log analysis device 10. As the rule information, there is set a table to convert (the value of) the viewing feature information of the viewing group into a text (word) which can intuitively indicate the viewing feature information.

Hereinafter, the description will be given about the rule information stored in the rule storage 13. The rule information stored in the rule storage 13 includes time zone name information and channel name information.

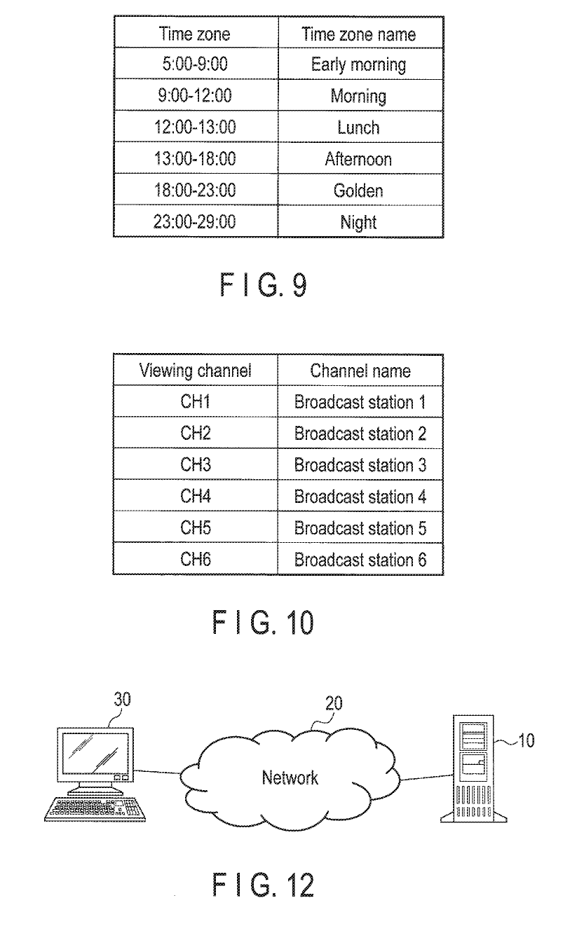

FIG. 9 illustrates an example of a data structure of the time zone name information. As illustrated in FIG. 9, the time zone name information includes a time zone name in association with the time zone.

The time zone indicates the time zone having a viewing habit of the broadcast program in (the plurality of viewing devices belonging to) the viewing group. The time zone name indicates the name (the time zone name) assigned with respect to the time zone associated with the time zone name.

In the example illustrated in FIG. 9, the time zone name information includes the time zone name “early morning” in association with the time zone “5:00-9:00”, “morning” in association with the time zone “9:00-12:00”, the time zone name “lunch” in association with the time zone “12:00-13:00”, the time zone name “afternoon” in association with the time zone “13:00-18:00”, the time zone name “golden” in association with the time zone “18:00-23:00”, and the time zone name “night” in association with the time zone “23:00-29:00 (5:00)”.

FIG. 10 illustrates an example of a data structure of the channel name information. As illustrated in FIG. 10, the channel name information includes a channel name in association with the viewing channel.

The viewing channel indicates a channel through which the broadcast program is viewed in the viewing group. The channel name indicates the name (channel name) assigned to the viewing channel associated with the channel name. Further, a broadcast station name may be used as the channel name.

In the example illustrated in FIG. 10, the channel name information includes the channel name “Broadcast station 1” in association with the viewing channel “CH1”, the channel name “Broadcast station 2” in association with the viewing channel “CH2”, the channel name “Broadcast station 3” in association with the viewing channel “CH3”, the channel name “Broadcast station 4” in association with the viewing channel “CH4”, the channel name “Broadcast station 5” in association with the viewing channel “CH5”, and the channel name “Broadcast station 6” in association with the viewing channel “CH6”.

In this embodiment, the viewing habit name may be generated on the basis of (the rule information including) the time zone name information and the channel name information.

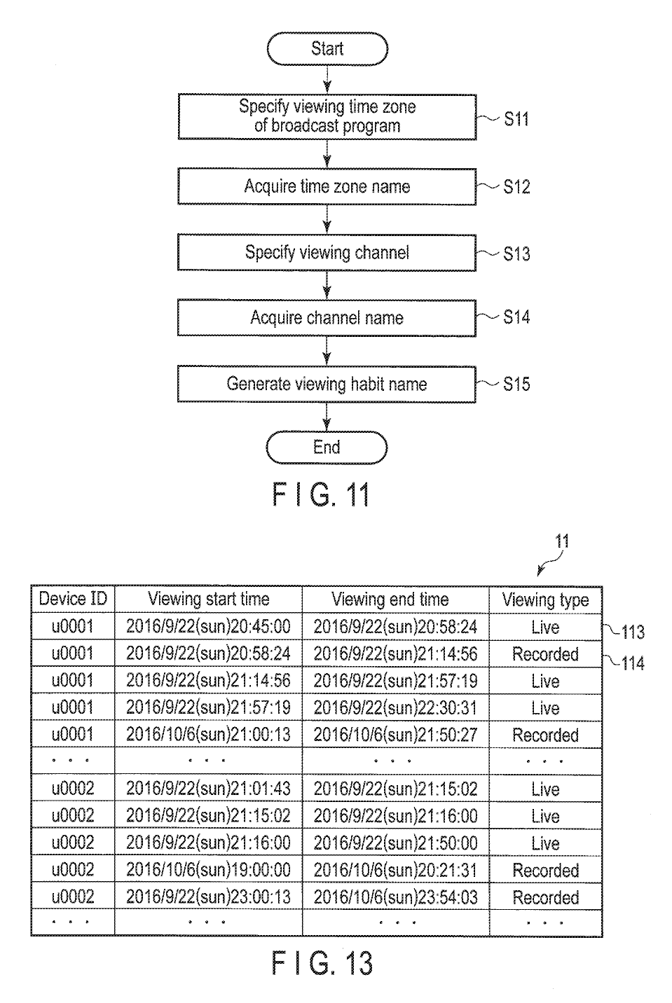

Next, an example of a procedure of generating the viewing habit name will be described with reference to a flowchart of FIG. 11.

First, the display control module 123 specifies the time zone (hereinafter, referred to as viewing time zone) in which the broadcast program is viewed in the viewing habit based, on the viewing feature information of the viewing group (Step S11).

In Step S11, for example, the time zone (a time zone related to the viewing feature amount) corresponding to the highest viewing feature amount among the viewing feature amounts included in the viewing feature information of the viewing group (the viewing feature information of Sunday) is specified as the viewing time zone.

Specifically, for example, in the viewing feature information of the viewing group visualized and displayed as illustrated in FIG. 7, the time zone from 9 to 10 o'clock is specified as the time zone corresponding to the highest viewing feature amount included in the viewing feature information. Further, in the example illustrated in FIG. 7, the fourth color (the color to be assigned in the case of 0.6≤f<0.8) is assigned to both of the area 403 corresponding to the time zone from 9 to 10 o'clock and the area 406 corresponding to the time zone from 12 to 13 o'clock. It is assumed that the ratio of viewing the broadcast. program on CH4 in the time zone from 9 to 10 o'clock on Sunday is higher than the ratio of viewing the broadcast program on CH5 in the time zone from 12 to 13 o'clock on Sunday.

When the process of Step S11 is performed, the display control module 123 acquires the time zone name with reference to (the time zone name information included in) the rule information stored in the rule storage 13 (Step S12). In this case, the display control module 123 acquires the time zone name included in the zone name information in association with the time zone containing the viewing time zone which is specified in Step S11.

Making an explanation in detail using the time zone name information illustrated in FIG. 9, as described above, in a case where the time zone from 9 to 10 o'clock is specified as the viewing time zone in Step S11 for example, the display control module 123 acquires the time zone name “morning” included in the time zone name information in association with the time zone “9:00-12:00” containing the viewing time zone.

Next, the display control module 123 specifies the viewing channel through which the broadcast program is viewed in the viewing habit based on the viewing feature information of the viewing group (Step S13).

In Step S13, for example, the viewing channel (a channel related to the viewing feature amount) associated with the highest viewing feature amount among the viewing feature amounts included in the viewing feature information of the viewing group is specified. In other words, the viewing channel through which the broadcast program is viewed in the viewing time zone specified in Step S11 is specified.

Specifically, for example, in the viewing feature information of the viewing group visualized and displayed as illustrated in FIG. 7, CH4 is specified as the viewing channel (that is, the viewing channel through which the broadcast program is viewed in the time zone from 9 to 10 o'clock specified in Step S11) associated with the highest viewing feature amount included in the viewing feature information.

When the process of Step S13 is performed, the display control module 123 acquires the channel name with reference to (channel name information) the rule information stored in the rule storage 13 (Step S14). In this case, the display control module 123 acquires the channel name included in the channel name information in association with the viewing channel specified in Step S13.

Making an explanation in detail using the channel name information illustrated in FIG. 10, in a case where CH4 is specified as the viewing channel in Step S13 for example as described above, the display control module 123 acquires the channel name “Broadcast station 4” included in the channel name information in association with the viewing channel “CH4”.

Next, on the basis of the time zone name acquired in Step S12 and the channel name acquired in Step S14, the display control module 123 generates the viewing habit name indicating the viewing habit based on the viewing feature information of the viewing group (Step S15).

In Step S15, the display control module 123 generates the viewing habit name by combining the time zone name and the channel name. In other words, the display control module 123 can generate the viewing habit name by setting the time zone name and the channel name to a prepared template.

Specifically, as described above, in a case where the time zone name acquired in Step S12 is “morning” and the channel name acquired in Step S14 is “Broadcast station 4”, it is possible to generate the viewing habit name such as “Broadcast station 4 in the morning” for example. The viewing habit name is displayed together with the viewing feature information of the viewing group in a graph format illustrated in FIG. 7, and therefore it is possible to present the viewing habit that the broadcast program on CH4 is viewed in the time zone of the morning. The viewing habit name generated by the display control module 123 may be displayed by being automatically attached to, for example, the viewing feature information of the viewing group in a graph format, or may he displayed in a case where the displaying of the viewing habit name is designated by an analyst.

Further, while the description has been given about a case where one viewing time zone and one viewing channel are specified in Steps S11 and S13 illustrated in FIG. 11, it is also possible to specify, for example, a plurality of viewing time zones and viewing channels. For example, the viewing time zones and the viewing channels may he specified as many as the viewing feature amount equal to or more than a predetermined value (for example, 0.6).

Specifically, in the example illustrated in FIG. 7, the time zone from 9 to 10 o'clock and the time zone from 12 to 13 o'clock are specified as the viewing time zone in Step S11, and “morning” and “lunch” are acquired as the time zone name in Step S12.

In addition, CH4 and CH5 are specified as the viewing channel in Step S13, and “Broadcast station 4” and “Broadcast station 5” are acquired as the channel name in Step S14.

Therefore, in Step S15 described above, for example, the viewing habit name such as “Broadcast station 4 in the morning, and Broadcast station 5 in the lunch” may be generated.

According to the process illustrated in FIG. 11, it is possible to generate the viewing habit name indicating the viewing habit on the basis of the viewing time zone and the viewing channel related to the viewing feature amount which is included in the viewing feature information of the viewing group.

Further, in a case where, the viewing feature information of the plurality of viewing groups is displayed as illustrated in FIG. 8 described above, the process illustrated in FIG. 11 is performed on each of the viewing feature information of the plurality of viewing groups. Therefore, it is possible to generate each viewing habit name based on each of the viewing feature information of the plurality of viewing groups.

In addition, while this embodiment has been described such that the process illustrated in FIG. 11 is performed separately from the process illustrated in FIG. 3, it may be configured such that the process illustrated in FIG. 11 is performed after Step S5 illustrated in FIG. 3 is performed for example, and the viewing habit name generated by the process illustrated in FIG. 11 is displayed together with the viewing feature information of the viewing group in Step S6.

Further, the description in FIG. 11 has been described such that the viewing habit name indicating the viewing habit is generated on the basis of the time zone (time zone name) and the viewing channel (channel name). However, the viewing habit name may be generated using (the name of) the day for example. As described above, in a case where the viewing group is generated on the basis of the viewing feature information of Sunday of the viewing device, the time zone name acquired in Step S12 is “morning”, and the channel name acquired in Step S14 is “Broadcast station. 4”, the viewing habit name “Broadcast station 4 in the morning on Sunday” may be generated for example.

As described above, in this embodiment, the viewing log collected from each of the plurality of viewing devices used to view the broadcast program is acquired, the viewing feature information including the viewing feature amount related to the combination of the day, the time zone, and the viewing channel in the viewing log is calculated for each viewing device, the viewing group including the plurality of viewing devices similar in the viewing feature information is generated, and the viewing habit in the viewing group is displayed on the basis of the viewing feature amount included in the viewing feature information with respect to each of the plurality of viewing devices in the viewing group.

In this embodiment, a group of viewing devices similar in the viewing feature information is automatically generated as described above, so that an unknown viewing habit (featured viewing pattern) related to (the combination of) the day, the time zone, and the viewing channel can be presented (extracted) even when the information such as the broadcast program and the time zone is not set on the basis of knowledge or an assumption of an analyst for example.

Further, in this embodiment, with the configuration of generating the name (the viewing habit name) indicating the viewing habit in the viewing group on the basis of the combination of the time zone and the viewing channel related to the viewing feature amount included in the generated viewing feature information (that is, the viewing feature information of the viewing group) with respect to each of the plurality of viewing devices which belong to the viewing group, it is possible to present the viewing habit to make easy understand compared to the case of (the viewing feature information of the viewing group of) the graph format.

The viewing habit presented in this embodiment can be used to improve the quality of various services. Specifically, it is possible to efficiently achieve an advertising effect by developing an advertisement according to the viewing habit. Further, for example, in a case where information such as the age of the user (that is, the viewer) of the viewing device collecting the viewing log is obtained together with the viewing log, it is possible to produce the broadcast program for the age group of the viewer who views the broadcast program by the viewing habit presented in this embodiment. Likewise, the efficient development of advertisements and the production of the broadcast programs can be realized by using the viewing habit extracted in this embodiment. For example, when being analyzed using a combination of detail information (for example, guests and genre) of the broadcast program and the information of the viewer (for example, age and address), the viewing habit presented in this embodiment can be more informative for the development of the advertisement and the production of the broadcast program.

Further, while the description in this embodiment has been given about an example in which the viewing feature information of the viewing group is visualized and displayed in a graph format as illustrated in FIG. 7 described above, the viewing feature information of the viewing group may be displayed in other formats.

Specifically, the viewing feature information of the viewing group may be displayed in a table format similar to the viewing feature information of the viewing device illustrated in FIG. 4. In addition, for example, a bubble chart may be displayed in accordance with the number of the viewing devices belonging to the viewing group, and the viewing feature information of the viewing group designated in the bubble chart may be displayed in a graph format. Further, while the description in this embodiment has been given about an example in which the viewing habit name is displayed together with the viewing feature information of the viewing group displayed in a graph format, only the viewing habit name (text) for all (or some) of the viewing feature information of the viewing group may be displayed in a list in order to simply present all the viewing feature information. Further, while the description in this embodiment has been given about an example in which the viewing feature information of the viewing group is displayed using (a graph of) two axes of the vertical axis (time zone) and the horizontal axis (viewing channel), the viewing feature information of the viewing group may be displayed using three axes for example.

In addition, while the description in this embodiment has been given about an example in which the viewing feature information including the viewing feature amount related to the combination of the day, the time zone, and the viewing channel included in the viewing log is generated for each viewing device, and the plurality of viewing devices similar in the viewing feature information are generated as the viewing group, the viewing group may be generated on the basis of the viewing feature information including the viewing feature amount related to the combination of the day and the time zone for example.

In the case of such a configuration, it is not possible to present the viewing habit related to the viewing channel (where the broadcast program is viewed) which is used by the viewer. However, at least it is possible to present the viewing habit related to the time zone for each day when the broadcast program is viewed in the viewing device. Even such a viewing habit can be used for the development of the advertisement and the production of the broadcast program.

Further, while the description in this embodiment has been given about an example in which the viewing habit in the day, the time zone, and the viewing channel is extracted by generating the viewing feature information including the viewing feature amount related to the combination of the day, the time zone, and the viewing channel, the viewing habit on a holiday may be extracted by generating the viewing feature information including the viewing feature amount related to a combination of the holiday in place of the day, the time zone, and the viewing channel for example.

In addition, in this embodiment, the viewing feature information of the viewing group may be displayed in a display unit (not illustrated) which is provided in the viewing log analysis device 10. Further, as illustrated in FIG. 12, the viewing log analysis device 10 may be operated as a server device, and the viewing feature information of the viewing group may be displayed in a user terminal 30 which is connected to the viewing log analysis device 10 through a network 20. Further, the configuration is the same in the following embodiment.

### SECOND EMBODIMENT

Next, a second embodiment will be described. This embodiment is different from the first embodiment in that the viewing habit in (a combination of) the day, the time zone, and a viewing type is presented (extracted). In the following description, the description of the same portions as those of the first embodiment will be omitted, and be focused on the portions different from those of the first embodiment.

Further, a configuration of the viewing log analysis device according to this embodiment is the same as that of the first embodiment, and thus will be roughly described using FIG. 1.

First, the viewing log storage 11 equipped in the viewing log analysis device 10 according to this embodiment will be described with reference to FIG. 13. FIG. 13 illustrates an example of the data structure of the viewing log stored in the viewing log storage 11.

As illustrated in FIG. 13, the viewing log stored in the viewing log storage 11 includes the viewing start time, the viewing end time, and the viewing type in association with the device ID. The device ID, the viewing start time, and the viewing end time are the same as those of the first embodiment, and thus the description thereof will be omitted.

The viewing type is a type of viewing the broadcast program in the viewing device which is identified by the device ID associated with the viewing type and, for example, includes a live (viewing) type and a recorded (viewing) type. In this embodiment, the live (viewing) type includes a real-time viewing of the broadcast program which is broadcasting (viewing the broadcast program which is actually broadcasting). The recorded (viewing) type is a viewing of the broadcast. program which was recorded.

In the example illustrated in FIG. 13, for example, the plurality of viewing logs including the viewing logs 113 and 114 are illustrated as the viewing log collected from the viewing device identified by the device ID “u0001”.

Specifically, the viewing log 113 includes the viewing start time “2016/9/22 (Sun) 20:45:00”, the viewing end time “2016/9/22 (Sun) 20:58:24”, and the viewing type “live” in association with the device ID “u0001”. According to the viewing log 113, there is indicated that the broadcast program (hereinafter, referred to as live broadcast program) which was actually broadcasted was viewed in the time zone from the viewing start time to the viewing end time included in the viewing log 113 in the viewing device identified. by the device ID “u0001”.

In addition, the viewing log 114 includes the viewing start time “2016/9/22 (Sun) 20:58:24”, the viewing end time “2016/9/22 (Sun) 21:14:56”, and the viewing type “recorded” in association with the device ID “u0001”. According to the viewing log 114, there is indicated that the recorded broadcast program (hereinafter, referred to as recorded broadcast program) was viewed in the time zone from the viewing start time to the viewing end time included in the viewing log 114 in the viewing device identified by the device ID “u0001”.

Further, the viewing log 113 including the viewing type “live” is a viewing log which is stored in the viewing log storage 11 in a case where the viewing device is powered on at the viewing start time included in the viewing log 113 (that is, the viewing of the live broadcast program starts), and the recorded broadcast program starts to be reproduced at the viewing end time included in the viewing log 113 (that is, the viewing of the live broadcast program ends).

On the other hand, the viewing log 114 is a viewing log which is stored in the viewing log storage 11 in a case where the recorded broadcast program starts to be reproduced at the viewing start time included in the viewing log 114, and the reproducing of the recorded broadcast program is stopped at the viewing end time included in the viewing log 114 as described above.

Herein, while the detailed description will be omitted, the viewing log collected from the viewing device identified by the device ID “u0001” is stored in the viewing log storage 11 except the viewing logs 113 and 114.

In addition, the plurality of viewing logs including the device ID “u0002” are included in the example illustrated in FIG. 13 as the viewing log collected from the viewing device identified by the device ID “u0002” for example.

Further, (the data structure of) the viewing log collected from the viewing device identified by the device ID “u0002” is the same as the viewing log (for example, the viewing logs 113 and 114) collected from the viewing device identified by the device ID “u0001”,and thus the description thereof will be omitted.

In FIG. 13, only the viewing log collected. from the viewing device identified by the device IDs “u0001” and “u0002” is illustrated, but the viewing logs collected from the other viewing devices are similarly stored in the viewing log storage 11.

Further, the viewing log in this embodiment is assumed to indicate one viewing behavior. In this embodiment, the viewing behavior indicated by one viewing log starts by changing the channel, turning on the power of the viewing device, or reproducing the recorded broadcast program, and then ends by changing the channel, turning off the viewing device, or stopping the reproducing of the recorded broadcast program.

Next, a procedure of the viewing log analysis device 10 according to this embodiment will be described. Further, the procedure of the viewing log analysis device 10 according to this embodiment is the same as that illustrated in FIG. 3, and will be described using FIG. 3.

First, the process of Step S1 described in the first embodiment is performed. In Step S1, the acquisition module 121 acquires the viewing log (the viewing log of the target viewing device) including the target device ID.

Next, the generating module 122 generates the viewing feature information (hereinafter, referred to as the viewing feature information of the target viewing device) including the viewing feature amount related to the combination of the day, the time zone, and the viewing type included in the viewing log on the basis of the viewing log of the target viewing device (Step S2). In this case, the generating module 122 calculates, for example, a ratio of the time for viewing the broadcast program (viewing time) in each viewing type in each time zone of each day as the viewing feature amount, and generates the viewing feature information including the viewing feature amount.

Herein, for example, the description will be given about a case where a ratio of the time for viewing the live broadcast program (viewing time) in the time zone from 0 to 1 o'clock on Sunday (that is, the viewing feature amount related to the combination of Sunday, the time zone from 0 to 1 o'clock, and the live viewing) is calculated. In this case, the generating module 122 specifies the time for viewing the live broadcast program between 0 and 1 o'clock on Sunday on the basis of the viewing log of the target viewing device. The generating module 122 calculates the viewing feature amount by dividing the specified time by one hour from 0 to 1 o'clock. For example, in a case where the time for viewing the live broadcast program between 0 and 1 o'clock on Sunday is 30 minutes, 0.5 is calculated as the viewing feature amount.

Further, as described above, in a case where the viewing log of the target viewing device is collected in one month, the generating module 122 calculates an average value of the ratio of the time for viewing the live broadcast program between 0 and 1 o'clock on Sunday as the viewing feature amount.

The generating module 122 performs the process on each combination of the day, the time zone, and the viewing channel to generate the viewing feature information including the viewing feature amount calculated for each combination.

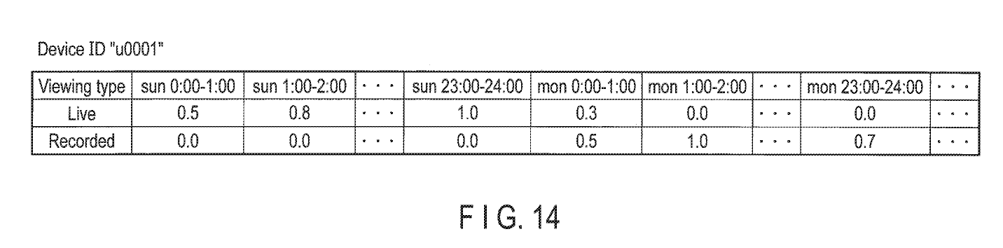

The viewing feature information of the target viewing device generated in Step S2 in this embodiment will be specifically described with reference to FIG. 14. As illustrated in FIG. 14, the viewing feature information includes the viewing feature amount which is calculated for each combination of the day, the time zone, and the viewing type.

In the example illustrated in FIG. 14, the viewing feature information includes a viewing feature amount of “0.5” in association with the viewing type “live”, and “Sun 0:00-1:00” which is the combination of the day, and the time zone. Therefore, the example shows that the ratio (viewing feature amount) of the time for viewing the live broadcast program between 0 and 1 o'clock on Sunday is 0.5. In other words, the example shows that the live broadcast program is viewed in the target viewing device in 30 minutes in one hour from 0 to 1 o'clock on Sunday.

In addition, the viewing feature information includes a viewing feature amount of “0.8” in association with the viewing type “live” and “Sun 1:00-2:00” which is the combination of the day, and the time zone. Therefore, the ratio (viewing feature amount) of the time for viewing the live broadcast program between 1 and 2 o'clock on Sunday is 0.8. In other words, the live broadcast program is viewed in the target viewing device in 48 minutes in one hour between 1 to 2 o'clock on Sunday.

As illustrated in FIG. 14, the viewing feature information includes the ratio of the time for viewing the live broadcast program in the time zone every one hour on Sunday as the viewing feature amount.

Herein, while the description has been given about Sunday, even in the case of the other days, the ratio of the time for viewing the live broadcast program in the time zone every one hour is similarly included in the viewing feature information as the viewing feature amount. In addition, also the viewing type (that is, recorded) other than the live (viewing) type is the same.

In the following description, among the plurality of viewing feature amounts included in the viewing feature information, a group of ratios (viewing feature amount) of the time for viewing the broadcast program in each viewing type in each time zone of Sunday will be called the viewing feature information of Sunday for convenience sake. Further, in this embodiment, each time zone of Sunday is the same as that of the first embodiment described above, and is displayed as 5 to 29 o'clock for example.

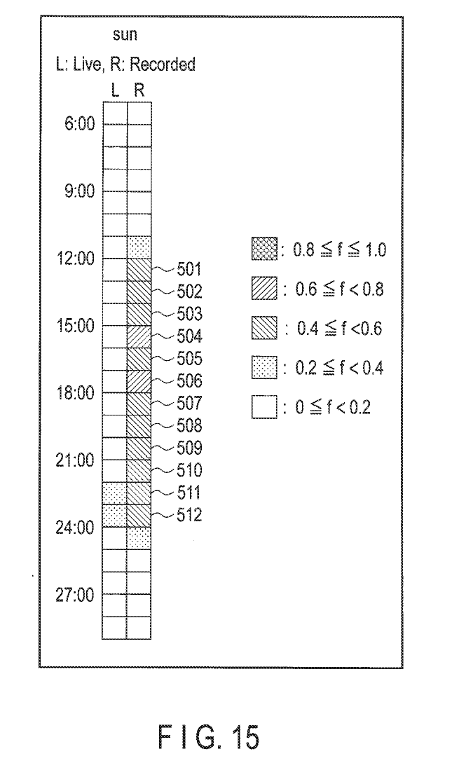

Herein, the description will be given with reference of FIG. 15 about an example in which the viewing feature information of Sunday of the target viewing device is visualized (imaged) in a graph format.

In FIG. 15, the vertical axis represents the time zone (time), and the horizontal axis represents the viewing type. The graph configured by the vertical axis and the horizontal axis includes a plurality of areas, each of which corresponds to the time zone and the viewing type. Further, in FIG. 15, a viewing type L indicates the live (viewing) type, and a viewing type R indicates the recorded (viewing) type.

Each of the plurality of areas of the graph is assigned with a color according to (the value of) the viewing feature amount corresponding to each time zone and each viewing type. Further, the viewing feature amount corresponding to each time zone and each viewing type is a ratio of the time for viewing the broadcast program in the viewing type in the time zone.

The color assigned to each of the plurality of areas includes, for example, first to fifth colors. Herein, in a case where the viewing feature amount is set to f, a first color is, for example, a color assigned to the area according to the viewing feature amount of 0 or more and less than 0.2 (0≤f≤0.2). A second color is, for example, a color assigned to the area according to the viewing feature amount of 0.2 or more and less than 0.4 (0.2≤f≤0.4). A third color is, for example, a color assigned to the area according to the viewing feature amount of 0.4 or more and less than 0.6 (0.4≤f≤0.6). A fourth color is, for example, a color assigned to the area according to the viewing feature amount of 0.6 or more and less than 0.8 (0.6≤f≤0.8). A fifth color is, for example, a color assigned to the area according to the viewing feature amount of 0.8 or more and 1.0 or less (0.8≤f≤1.0).

In the example illustrated in FIG. 15, for example, areas 501 to 503 corresponding to the time zone from 12 to 15 o'clock and to a recorded viewing (21) are assigned by the third color, and an area 504 corresponding to the time zone from 15 to 16 o'clock and to the recorded viewing (R) is assigned by the fourth color. In addition, an area 505 corresponding to the time zone from 16 to 17 o'clock and the recorded viewing (R) is assigned by the third color, an area 506 corresponding to the time zone from 17 to 18 o'clock and the recorded viewing (R) is assigned by the fourth color, and areas 507 to 512 corresponding to the time zone from 18 to 24 o'clock and the recorded viewing (R) is assigned by the third color.

According to such a viewing feature amount, it is indicated that there is a habit of viewing the recorded broadcast program from the morning to the middle of the night on Sunday in the target viewing device.

While the description in FIG. 15 has been given about an example of visualizing the viewing feature information of Sunday of the target viewing device in a graph format, this is the same even in the case of the viewing feature information of the other days of the target viewing device.

Making an explanation using FIG. 3 again, the process of Step S3 described in the first embodiment is performed. In other words, in a case where it is determined that the process is not performed on all the device IDs (NO of Step S3), the procedure returns to Step S1 and is repeatedly performed.

On the other hand, in a case where it is determined that the process is performed on all the device IDs (YES of Step S3), the process of Step S4 described in the first embodiment is performed. While being described in the first embodiment, the description of the process of Step S4 will be omitted. According to the process of Step S4, (the viewing group information indicating) the viewing group including the plurality of viewing devices similar in the viewing feature information is generated. Further, the data structure of the viewing group information is the same as the above description in FIG. 6, and thus the description thereof will be omitted.

Next, the display control module 123 generates the viewing feature information of the viewing group on the basis of the viewing feature amount included in each viewing feature information of the plurality of viewing devices belonging to the viewing group generated in Step S4 (Step S5).

In this case, the display control module 123 calculates, for example, an average value of the viewing feature amount of the viewing device (that is, the viewing device belonging to the viewing group) identified by the device ID included in the viewing group information indicating the viewing group, and generates the viewing feature information including the average value (viewing feature amount).

Herein, the process of Step S5 will be described in detail. Herein, for convenience' sake, it is assumed that first to third viewing devices belong to the viewing group generated in Step S4.

As described above, the viewing feature amount relating to each combination of the day, the time zone, and the viewing type is included in each viewing feature information of the first to third viewing devices.

Herein, in a case where the process of Step S4 described above is performed on the basis of the viewing feature information of Sunday, the display control module 123 calculates an average value of the viewing feature amount included in the viewing feature information of Sunday of the first to third viewing devices.

Specifically, the display control module 123 calculates the average value of the viewing feature amount related to the combination of Sunday, the time zone from 0 to 1 o'clock, and live viewing (a ratio of a time for viewing the broadcast program on live viewing in a time zone from 0 to 1 o'clock on Sunday) included in the viewing feature information of the first to third viewing devices as the viewing feature amount related to the combination of Sunday, the time zone from 0 to 1 o'clock, and live viewing in the viewing group.

Herein, while the description has been given about the combination of Sunday, the time zone from 0 to 1 o'clock, and live viewing, the display control module 123 can also generate the viewing feature information of the viewing group (the viewing feature information of Sunday) by calculating the viewing feature amount (average value) similarly with respect to a combination of Sunday, another time zone, and another viewing type (recorded viewing). The viewing feature information of the viewing group generated herein is information indicating the viewing habit on Sunday of the viewing group.

Next, the display control module 123 visualizes and displays (the viewing feature amount included in) the viewing feature information of the viewing group generated in Step S5 (Step S6).

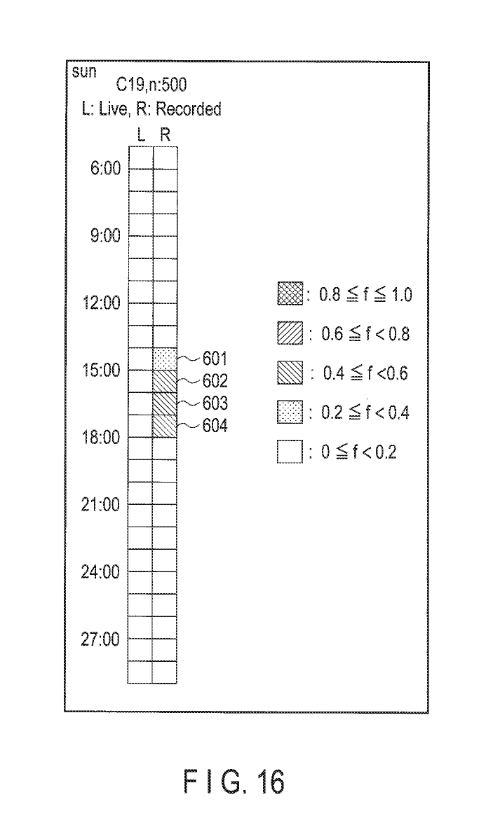

FIG. 16 illustrates a displaying example of the viewing feature information of the viewing group in Step S6. Further, in FIG. 16, there is illustrated an example in which the viewing feature information of one viewing group (the viewing feature information of Sunday) among the viewing feature information of K viewing groups generated in Step S5 is visualized (imaged) in a graph format.

In the upper portion of the graph illustrated in FIG. 16, “C19” is denoted as the viewing group ID for identifying the viewing group, and “500” is denoted as the number (n) of the viewing devices belonging to the viewing group. Further, the number of the viewing devices belonging to the viewing group corresponds to the number of device IDs included in the viewing group information in association with the viewing Group ID for identifying the viewing group.

In addition, in FIG. 16, the vertical axis represents the time zone (time), and the horizontal axis represents the viewing type. The graph configured by the vertical axis and the horizontal axis includes a plurality of areas in association with each time zone and each viewing type.

Each of the plurality of areas of the graph is assigned with color according to (the value) of the viewing feature amount corresponding to each time zone and each viewing type. Further, the colors assigned to the plurality of areas is the same as the above description in FIG. 15, and thus the description. thereof will be omitted.

In the example illustrated in FIG. 16, an area 601 corresponding to the time zone from 14 to 15 o'clock and the recorded viewing (R) is assigned by the second color, and areas 602 to 604 corresponding to the time zone from 15 to 16 o'clock and the recorded viewing (R) are assigned by the third color.

Therefore, it is possible to visualize that the viewing group identified by the viewing group ID “C19” (a group of 500 viewing devices) has a feature (habit) of viewing the recorded broadcast program in the afternoon.

According to the visualized viewing feature information of the viewing group (the viewing feature information of Sunday), the viewing habit of Sunday in the plurality of viewing devices (herein, 500 viewing devices) can be presented.

While not illustrated herein in detail, the viewing feature information of the viewing group identified by the viewing group ID other than the viewing group ID “C19” illustrated in FIG. 16 can be similarly visualized and displayed.

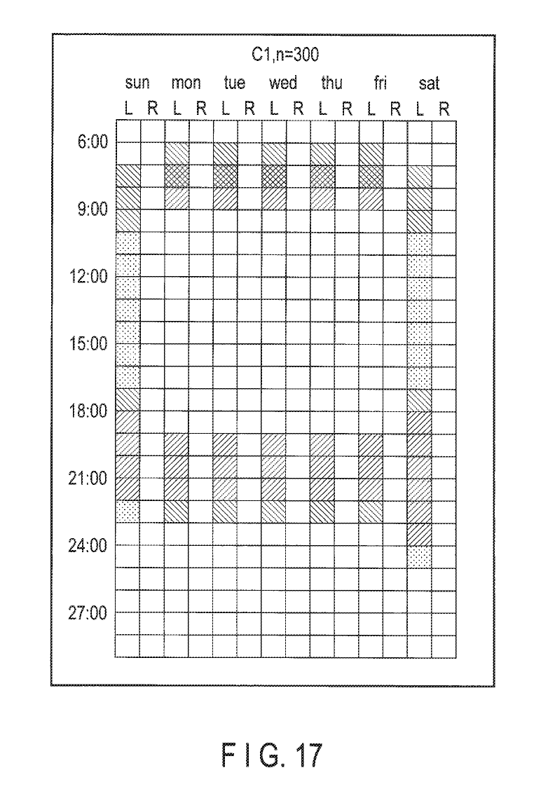

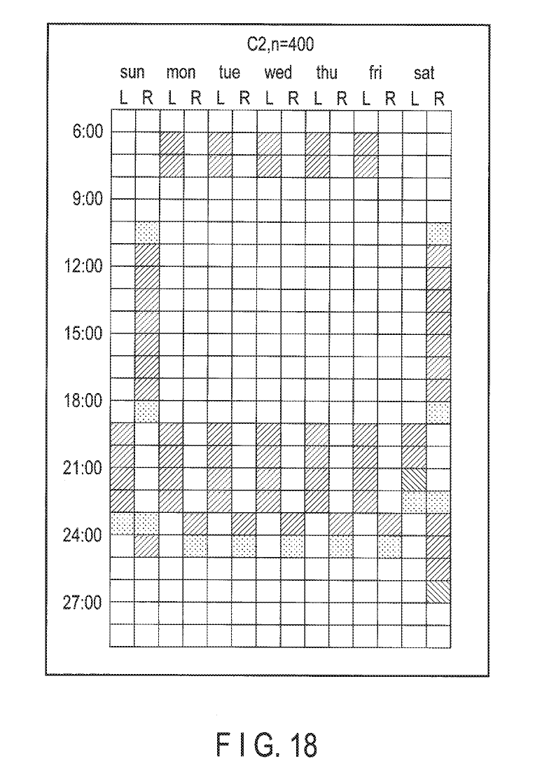

Further, the description herein has been given about an example in which the viewing group is generated on the basis of the viewing feature information of Sunday of the viewing device, and the viewing feature information of Sunday of the viewing group is displayed. However, the viewing group may be generated on the basis of the viewing feature information of all days of the viewing device. Therefore, for example, it is possible to visualize and display the viewing feature information of all days including Sunday as illustrated in FIGS. 17 and 18. In this case, it is possible to present the viewing habit of one week of the viewing group. While not described in detail, in the example illustrated in FIG. 17, there is visualized a feature (habit) that the live broadcast program is viewed mainly in the early morning and the golden time for one week. In addition, in the example illustrated in FIG. 18, there is visualized a feature (habit) that the recorded broadcast program is viewed in the afternoon and at night, and the live broadcast program is viewed in the golden time on Saturday and Sunday. In addition, in the example illustrated in FIG. 18, there is visualized a feature (habit) that the live broadcast program is viewed in the early morning and the golden time and the recorded broadcast program is viewed about one hour at night on weekdays.

Further, the description herein has been mainly given about an example that the viewing feature information of one viewing group is displayed. However, it is possible to present the viewing habit in various viewing group by displaying the viewing feature information of the plurality of viewing groups.

Herein, this embodiment is configured to generate the name (viewing habit name) indicating the overview of the viewing habit as described in the first embodiment. The viewing habit name is generated using the rule information stored in the rule storage 13.

Hereinafter, the rule information stored in the rule storage 13 will be described in this embodiment. The rule information stored in the rule storage 13 includes the time zone name information and viewing type name information. Further, the time zone name information has been described in FIG. 9, and thus the description thereof will be omitted.

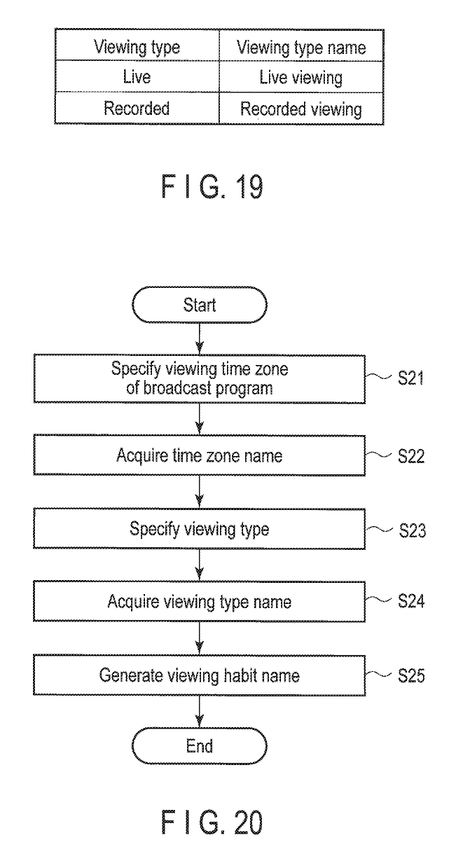

FIG. 19 illustrates an example of a data structure of the viewing type name information. As illustrated in FIG. 19, the viewing type name information includes a viewing type name in association with the viewing type.

The viewing type indicates a type of viewing the broadcast program in (the plurality of viewing devices included in) the viewing group and, for example, includes live and recorded types. The viewing type name indicates a name (viewing type name) assigned to the viewing type associated with the viewing type name.

In the example illustrated in FIG. 19, the viewing type name information includes the viewing type name “live viewing” in association with the viewing type “live” and “recorded viewing” in association with the viewing type “recorded”.

In this embodiment, the viewing habit name can be generated on the basis of (the rule information including) the time zone name information and the viewing type name information.

Next, an example of the procedure of generating the viewing habit name will be described with reference to a flowchart of FIG. 20.

First, the process of Steps S21 and S22 corresponding to the process of Steps S11 and S12 illustrated in FIG. 11 is performed.

Next, the display control module 123 specifies the viewing type of the broadcast program which is viewed by the viewing habit based on the viewing feature information of the viewing group (Step S23).

In Step S23, for example, the viewing type corresponding to the highest viewing feature amount (the viewing type related to the viewing feature amount) is specified among the viewing feature amounts included in the viewing feature information of the viewing group. In other words, the viewing type of the broadcast program to be viewed in the viewing time zone specified in Step S21 is specified.

Specifically, for example, the recorded type is specified as the viewing type corresponding to the highest viewing feature amount included in the viewing feature information in the viewing feature information of the viewing group which is visualized and displayed as illustrated in FIG. 16.

When the process of Step S23 is performed, the display control module 123 acquires the viewing type name with reference to the rule information stored in the rule storage 13 (viewing type name information) (Step S24). In this case, the display control module 123 acquires the viewing type name included in the viewing type name information in association with the viewing type specified in Step S23.

Making an explanation in detail using the viewing type name information illustrated in FIG. 19, in a case where the recorded type is specified as the viewing type in Step S23 as described above, the display control module 123 acquires the viewing type name “recorded viewing” included in the viewing type name information in association with the viewing type “recorded”.

Next, on the basis of the time zone name acquired in Step 522 and the viewing type name acquired in Step 524, the display control module 123 generates the viewing habit name indicating the viewing habit based on the viewing feature information of the viewing group (Step S25).

In Step S25, the display control module 123 generates the viewing habit name by combining the time zone name and the viewing type name. In other words, the display control module 123 can generate the viewing habit name by setting the time zone name and the viewing type name to a prepared template.

Specifically, in a case where the time zone name acquired in Step S22 is “afternoon” and the viewing type name acquired in Step S24 is “recorded viewing”, for example, the viewing habit name such as “the recorded viewing in the afternoon” can be generated. Since the viewing habit name is displayed together with the viewing feature information of the viewing group in a graph format illustrated in FIG. 7, it is possible to present the viewing habit that the recorded broadcast program is viewed in the afternoon time zone.

Further, while the description has been given about that one viewing time zone and one viewing type are specified in Steps S21 and S23 illustrated in FIG. 20, a plurality of viewing time zones and viewing types may be specified. For example, the viewing time zones and the viewing types corresponding to the viewing feature amount equal to or more than a predetermined value (for example, 0.6) may be specified.

Specifically, for example, in a case where the viewing feature information of all days of the viewing group as illustrated in FIG. 17 is displayed, the viewing habit name of “the live viewing in the early morning and the golden time” can be generated. In addition, the viewing habit name may be generated using (the name of) the day for example. For example, according to the example illustrated in FIG. 18, it is also possible to generate the viewing habit name such as “the live viewing in the early morning and the golden time on weekdays (Monday to Friday), the live viewing in the golden time on Saturday and Sunday, and the recorded viewing in the afternoon and at night on Saturday and Sunday”.

As described above, in this embodiment, the viewing log collected from each of the plurality of viewing devices used to view the broadcast program is acquired, the viewing feature information including the viewing feature amount related to the combination of the day, the time zone, and the viewing type included in the viewing log is calculated for each viewing device. The viewing group to which the plurality of viewing devices similar in the viewing feature information belong is generated. The viewing habit in the viewing group is displayed on the basis of the viewing feature amount included in the generated viewing feature information with respect to each of the plurality of viewing devices belonging to the viewing group.

In this embodiment, a group of viewing devices similar in the viewing feature information is automatically generated as described above, so that an unknown viewing habit (featured viewing pattern) related to (the combination of) the day, the time zone, and the viewing type can be presented (extracted) even when the information such as the broadcast program and the time zone is not set on the basis of knowledge or an assumption of an analyst for example.

Further, in this embodiment, with the configuration of generating the name (the viewing habit name) indicating the viewing habit in the viewing group on the basis of the combination of the time zone and the viewing type related to the viewing feature amount included in the generated viewing feature information (that is, the viewing feature information of the viewing group) with respect to each of the plurality of devices which belong to the viewing group, it is possible to present the viewing habit to make easy understand compared to the case of (the viewing feature information of the viewing group of) the graph format.

Further, while the description in this embodiment has been given about that the viewing type includes the “live” and “recorded” types, the “recorded” type may be divided into a case where the broadcast program recorded by the viewer is viewed and a case where the broadcast program automatically recorded by a function called a time shift is viewed for example. Therefore, it is possible to present the viewing habit in more detail.

In this embodiment, the description has been given about a case where an unknown viewing habit in the day, the time zone, and the viewing type is presented. For example, in a case where the viewing channel described in the first embodiment is included in the viewing log illustrated in FIG. 13, the viewing habit related to the day, the time zone, the viewing channel, and the viewing type may be present.

According to at least one of the above-described embodiments, it is possible to provide a viewing log analysis device, a method, and a storage medium which is able to present an unknown viewing habit on the basis of the viewing log.

While certain embodiments have been described, these embodiments have been presented by way of example only, and are not intended to limit the scope of the inventions. Indeed, the novel embodiments described herein may he embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A viewing log analysis device, comprising:
a hardware processor configured to:
acquire a viewing log for each device of a plurality of devices used to view a broadcast program, the viewing log comprising identification of a day when the broadcast program is viewed in the device and a time zone;
generate viewing feature information comprising a viewing feature amount related to a combination of the day and the time zone in the viewing log with respect to each of the plurality of devices;
generate a viewing group comprising a set of devices from the plurality of devices based on similarity or distance between the viewing feature information; and
display a viewing habit in the viewing group on the basis of the viewing feature amount in the viewing feature information with respect to each of the devices from the set of devices in the viewing group.

2. The viewing log analysis device of claim 1, wherein
the viewing log further comprises an identity of a channel through which the broadcast program viewed in the device is broadcasted, and
the hardware processor is further configured to calculate a viewing feature amount related to a combination of the day, the time zone, and the channel in the viewing log.

3. The viewing log analysis device of claim 2, wherein the hardware processor is further configured to:
generate a name indicating the viewing habit on the basis of a combination of the time zone and the channel related to the viewing feature amount in the viewing feature information with respect to each of the set of devices in the viewing group, and
display the viewing habit and the name.

4. The viewing log analysis device of claim 1, wherein
the viewing log further comprises a viewing type of the broadcast program in the device, and
the hardware processor is further configured to calculate a viewing feature amount related to a combination of the day, the time zone, and the viewing type in the viewing log.

5. The viewing log analysis device of claim 4,
wherein the viewing type comprises a type of viewing the broadcast program in real time and a type of viewing a recorded broadcast program.

6. The viewing log analysis device of claim 5, wherein the hardware processor is further configured to:
generate a name indicating the viewing habit on the basis of a combination of the time zone and the viewing type related to the viewing feature in the viewing feature information with respect to each of the set of devices in the viewing group, and
display the viewing habit and the name.

7. The viewing log analysis device of claim 1,
wherein the hardware processor is further configured to calculate the viewing feature amount on the basis of the viewing log collected in a particular time period.

8. A method that is performed by a viewing log analysis device, comprising:
acquiring a viewing log for each device of a plurality of devices used to view a broadcast program, the viewing log comprising identification of a day when the broadcast program is viewed in the device and a time zone;
generating viewing feature information comprising a viewing feature amount related to a combination of the day and the time zone in the viewing log with respect to each of the plurality of devices;
generating a viewing group comprising a set of devices from the plurality of devices based on similarity or distance between the viewing feature information; and
displaying a viewing habit in the viewing group on the basis of the viewing feature amount in the viewing feature information with respect to each of the devices from the set of devices in the viewing group.

9. A non-transitory computer-readable storage medium having stored thereon a computer program which is executable by a computer, the computer program comprising instructions capable of causing the computer to execute functions of:
acquiring a viewing log for each device of a plurality of devices used to view a broadcast program, the viewing log comprising identification of a day when the broadcast program is viewed in the device and a time zone;
generating viewing feature information comprising a viewing feature amount related to a combination of the, day and the time zone in the viewing log with respect to each of the plurality of devices;
generating a viewing group comprising a set of devices from the plurality or devices based on similarity or distance between the viewing feature information; and
displaying a viewing habit in the viewing group on the basis of the viewing feature amount in the viewing feature information with respect to each of the devices from the set of devices in the viewing group.
